(19) United States
(12) Patent Application Publication
(10) Pub. No.: US 2014/0052430 A1
(43) Pub. Date: Feb. 20, 2014

(54) Partitionless Multi User Support For Hardware Assisted Verification

(71) Applicant: Mentor Graphics Corporation, (US)

(72) Inventors: Krishnamurthy Suresh, Noida (IN); Charles W. Selvidge, Wellesley, MA (US)

(73) Assignee: Mentor Graphics Corporation, Wilsonville, OR (US)

(21) Appl. No.: 13/873,196

(22) Filed: Apr. 29, 2013

Related U.S. Application Data
(60) Provisional application No. 61/741,787, filed on Apr. 27, 2012.

(51) Int. Cl. G06F 17/50

(52) U.S. Cl. CPC G06F 17/5045
USPC 703/14

(57) ABSTRACT

Embodiments of the disclosed technology are directed toward facilitating the concurrent emulation of multiple electronic designs in a single emulator without partition restrictions. In certain exemplary embodiments, an emulation environment comprising an emulator and an emulation control station is provided. The emulation control station includes a model compaction module that is configured to combine multiple design models into a combined model. In some implementations, the design models are merged to form the combined model, where each design model is represented as a virtual design with the combined model. Subsequently, the emulator can be configured to implement the combined model. Furthermore, an emulation clock control component is provided that allows for portions of the emulated combined model to be “stalled” during emulation without affecting other portions.

### RELATED APPLICATIONS

This application claims priority under 35 U.S.C. §119 to U.S. Provisional Patent Application No. 61/741,787 (formerly U.S. patent application Ser. No. 13/458,041) entitled “Partitionless Multi-User Support For Hardware Assisted Verification,” filed on Apr. 27, 2012, and naming Charles Selvidge and Krishnamurthy Suresh as inventors, which application is incorporated entirely herein by reference.

### FIELD

The present application is directed towards the field of hardware emulation systems.

Various implementations of the invention may be particularly useful for facilitating the concurrent emulation of multiple electronic designs on a single emulator.

### BACKGROUND

Electronic circuits, such as integrated circuits, are used in a variety of products, from automobiles to microwaves to personal computers. Designing and fabricating these circuits involves many steps, known as a “design flow.” The particular steps of a design flow often are dependent upon the type of circuit being designed, its complexity, the design team, and the circuit fabricator or foundry that will manufacture the circuit. Typically, software and hardware “tools” will test a design at various stages of the design flow. The results of this testing then are used to identify and correct errors in the design. These testing processes are often referred to as verification, validation, or testing.

In some instances, verification will be facilitated by emulating the circuit design using a hardware emulator. Examples of hardware emulators include the VELOCE family of emulators available from Mentor Graphics Corporation of Wilsonville, Oreg. An emulator typically will provide a set of configurable components for mimicking the operation of a circuit design. For example, emulators that use field-programmable gate array circuits can emulate the functionality of a circuit design using a combination of state elements, memories and lookup tables. Of course, other types of emulators may provide additional or alternate primitive components. For example, an emulator may function by using combinatorial elements computing a selectable function over a fixed number of inputs.

In addition to verifying the functionality of circuit designs, hardware emulators are often used to test software designed to operate on the circuit. As those of ordinary skill in the art will appreciate, many modern circuit designs include both “hardware” content and “software” content. These types of circuits are often referred to as a system on a chip (“SoC” or “SOC”) and include multiple components packaged into the same circuit. Many SOC designs include a memory component that stores computer executable instructions designed to control some of the functionality or operation of the SOC. Hardware emulators then are used to allow the development and testing of these computer executable instructions prior to manufacturing of the circuit. As a result, development and testing of the “software” content of the circuit design can begin prior to manufacturing of the “hardware” content.

The size of a circuit design is typically measured in “gates.” In order to use a hardware emulator to verify the hardware or software of a circuit design, the emulator must have sufficient capacity to mimic the number of gates in the circuit design. As a result, hardware emulators are typically acquired based on the maximum number of gates intended to be emulated. As those of ordinary skill in the art will appreciate, the total emulator capacity is generally not needed until the end of the design flow. For example, the overall design is typically compartmentalized into sub-portions. These sub-portions then are designed and verified by individual design teams prior to being combined into the overall design. Furthermore, different versions of the software content are often tested on the same sub-portion of the design during the software development phase of an SOC design flow. The overall emulation capacity is not needed then when emulating the sub-portions during either the hardware verification phase or the software development phase of the design flow. Additionally, although the total emulator capacity needed corresponds to the largest design desired to be emulated, a designer can have multiple different design projects of varying size.

Emulators having sufficient capacity to emulate an entire modern integrated circuit are a significant capital expense costing many hundreds of thousands of dollars. Running an emulator at less than full capacity is therefore an inefficient use of this capital resource. Furthermore, allowing multiple “smaller” emulation projects to be executed concurrently can speed up design time accordingly. For example, multiple sub-portions of a larger design could be emulated simultaneously. Additionally, multiple versions of the software content of a design could be tested on the same sub-portion simultaneously.

Most conventional emulators include the ability to have their total capacity partitioned into smaller sections. Subsequently, multiple users can emulate their designs concurrently on these sections. As a result, the individual design teams mentioned above can use the same emulator to verify the sub-portions of the overall design that they are working on. Similarly, the same sub-portion of a circuit design can be instantiated in multiple sections. Subsequently, different software components can be verified on these partitions simultaneously. Additionally, multiple unrelated designs could be emulated on the same emulator simultaneously.

The ability to partition an emulator has many advantageous, such as reducing the amount of unused capacity during emulation. Partitioning techniques often have many restrictions however. For example, typically, a limit is imposed on the smallest capacity that the emulator can be partitioned into. Accordingly, for sub-portions of a circuit that are smaller than this limit, emulator capacity will still be unusable. Furthermore, some emulators limit the partitioning to an integral multiple of the minimum capacity limit.

Another way that partitioning is limited is by requiring that each partition occupy one or more emulator “boards.” As indicated above, hardware emulators provide a set of configurable components that may be arranged to behave like the circuit design. Typically, these configurable components are placed onto a “board,” which includes the necessary wiring and connection structure to interconnect the configurable components. A single emulator board will have the ability to emulate a specified number of gates. In order to increase the capacity of the emulator, multiple boards are often connected together. Typically, these boards are placed into a chassis or housing. Accordingly, many emulators restrict the emulator from being partitioned at less than the “board” level. More particularly, each partition must include one or more boards.

As can be appreciated, these restrictions often mean a significant amount of the total emulator's capacity is still unusable. For example, suppose an emulator with 12 boards and the ability to be partitioned at the board level were provided. Further suppose that a sub-portion of an SOC design that corresponded to the capacity of 1.2 boards (i.e. 10% of the total emulator capacity) were desired to be emulated in multiple partitions. Under this example, only 6 instances of the sub-portion could be instantiated in the emulator and 40% of the total emulator capacity would remain unusable.

### BRIEF SUMMARY OF THE INVENTION

Aspects of the invention are directed towards facilitating the concurrent emulation of multiple electronic designs in a single emulator without partition restrictions.

Various implementations provide an emulation environment comprising an emulator and an emulation control station. The emulation control station includes a model compaction module that is configured to combine multiple design models into a combined model. In some implementations, the design models are merged to form the combined model, where each design model is represented as a virtual model within the combined model. Subsequently, the emulator can be configured to implement the combined model.

The emulation environment further includes a virtual model link. The virtual model link is configured to facilitate message traffic between the emulator and the emulation control station during execution of the emulator. For example, trace information from one or more of the virtual models in the combined model can be received from the emulator through the virtual model link. In some implementations, trace information can be data received from one or more processors being emulated as part of the virtual models in the combined model. Furthermore, a clock management module is included in the emulator. The clock management module is configured to allow the clock for one of the virtual models in the combined model to be paused during emulation without affecting the clocks for the other virtual models.

These and additional implementations of invention will be further understood from the following detailed disclosure of illustrative embodiments.

### BRIEF DESCRIPTION OF THE DRAWINGS

The present application will be described by way of illustrative implementations shown in the accompanying drawings in which like references denote similar elements, and in which:

FIGS. 1 illustrates a programmable computing device.

FIG. 2A illustrates an exemplary emulation environment.

FIG. 2B illustrates an exemplary design under test that may be implemented in the emulation environment of FIG. 2.

FIG. 3 illustrates another exemplary emulation environment.

FIG. 4 illustrates a portion of the emulation environment of FIGS. 2 and 3 in further detail.

FIG. 5 illustrates an exemplary method of concurrently emulating multiple electronic designs in a single emulator.

FIG. 6 illustrates an exemplary method of initiating emulation of one of many designs implemented in an emulator.

FIG. 7A illustrates an exemplary method of generating a combined model.

FIG. 7B illustrates an exemplary combined model that may be generated by the method of FIG. 7A.

### DETAILED DESCRIPTION

The operations of the disclosed implementations may be described herein in a particular sequential order. However, it should be understood that this manner of description encompasses rearrangements, unless a particular ordering is required by specific language set forth below. For example, operations described sequentially may in some cases be rearranged or performed concurrently. Moreover, for the sake of simplicity, the illustrated flow charts and block diagrams typically do not show the various ways in which particular methods can be used in conjunction with other methods. Additionally, as used herein, the term “and/or” means any one item or combination of items in the phrase

It should also be noted that the detailed description sometimes uses terms like “generate” to describe the disclosed implementations. Such terms are often high-level abstractions of the actual operations that are performed. The actual operations that correspond to these terms may vary depending on the particular implementation.

### Illustrative Operating Environment

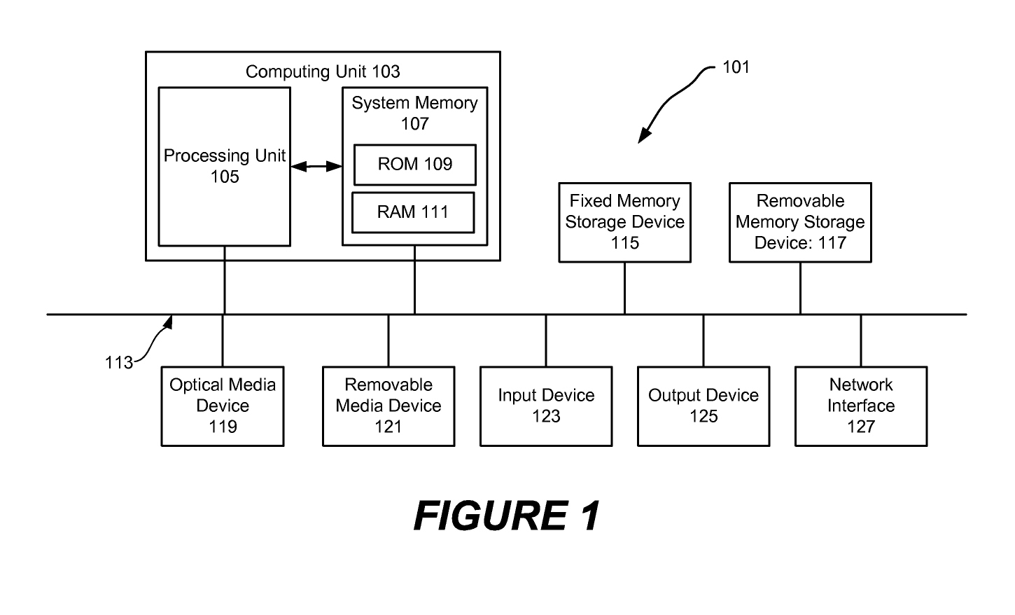

Because certain embodiments detailed herein can be implemented by a computer system executing software instructions, the components and operation of an exemplary computer system on which various implementations of the invention may be employed is described. FIG. 1 shows an illustrative computing device 101. As seen in this figure, the computing device 101 includes a computing unit 103 having a processing unit 105 and a system memory 107. The processing unit 105 may be any type of programmable electronic device for executing software instructions, but will conventionally be one or more microprocessors. The system memory 107 may include both a read-only memory (“ROM”) 109 and a random access memory (“RAM”) 111. As will be appreciated by those of ordinary skill in the art, both the ROM 109 and the RAM 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional devices, such as: a fixed memory storage device 115, for example, a magnetic disk drive or solid state memory device; a removable memory storage device 117, for example, a removable solid state disk drive; an optical media device 119, for example, a digital video disk drive; or a removable media device 121. The processing unit 105 and the system memory 107 also may be directly or indirectly connected to one or more input devices 123 and one or more output devices 125. The input devices 123 may include, for example, a keyboard, a pointing device (such as a mouse, touchscreen, touchpad, stylus, trackball, or joystick), a scanner, a camera, and/or a microphone. The output devices 125 may include, for example, a monitor display, a touchscreen, a printer and/or speakers. With various examples of the computing device 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (“USB”) connection.

In some implementations, the computing unit 103 is directly or indirectly connected to one or more network interfaces 127 for communicating with other devices making up a network. The network interface 127 translates data and control signals from the computing unit 103 into network messages according to one or more communication protocols, such as the transmission control protocol (“TCP”) and/or the Internet protocol (“IP”). Also, the interface 127 may employ any suitable connection agent (or combination of agents) for connecting to a network, including, for example, a wireless transceiver, a modem, or an Ethernet connection.

It should be appreciated that the computing device 101 is shown here for illustrative purposes only, and it is not intended to be limiting. Various embodiments of the invention may be implemented using one or more computers that include the components of the computing device 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

As stated above, various embodiments of the invention may be implemented using a programmable computer system executing software instructions, a computer readable medium having computer-executable software instructions stored thereon, or some combination thereof. Particularly, these software instructions may be stored on one or more computer readable media or devices, such as, for example, the system memory 107, fixed memory storage device 115, removable memory storage device 117, removable media device 121, or an optical disk for use in the optical media device 119. As those of ordinary skill in the art will appreciate, software instructions stored in the manner described herein are inherently non-transitory in nature. More specifically, the software instructions are available for execution by the computer system 101, as opposed to being transmitted to the computer system via a carrier wave or some other transitory signal.

### Partitionless Concurrent Emulation

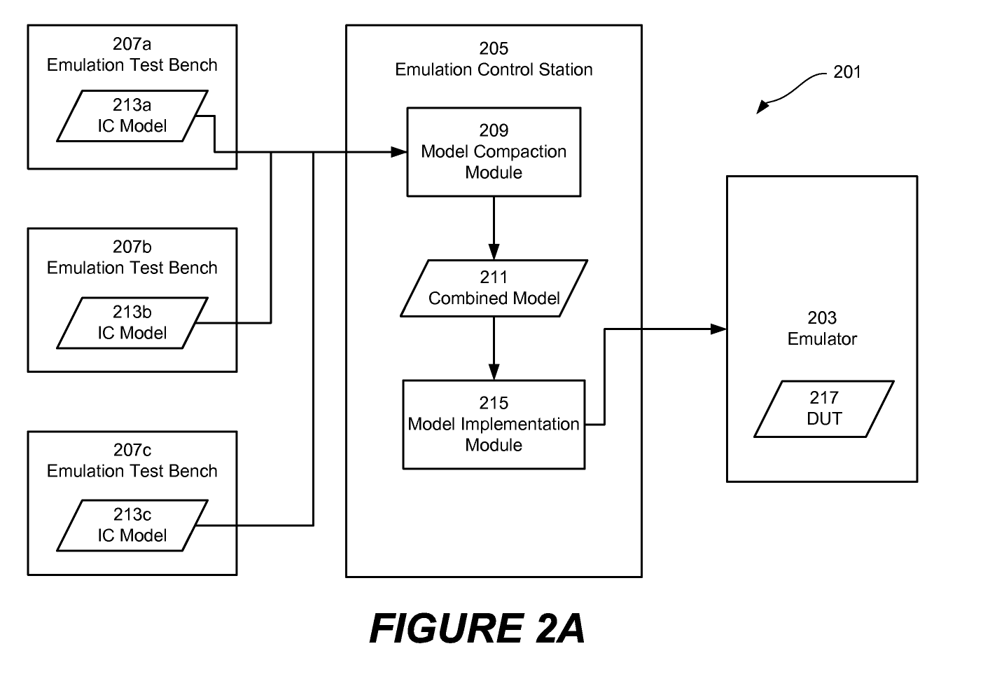

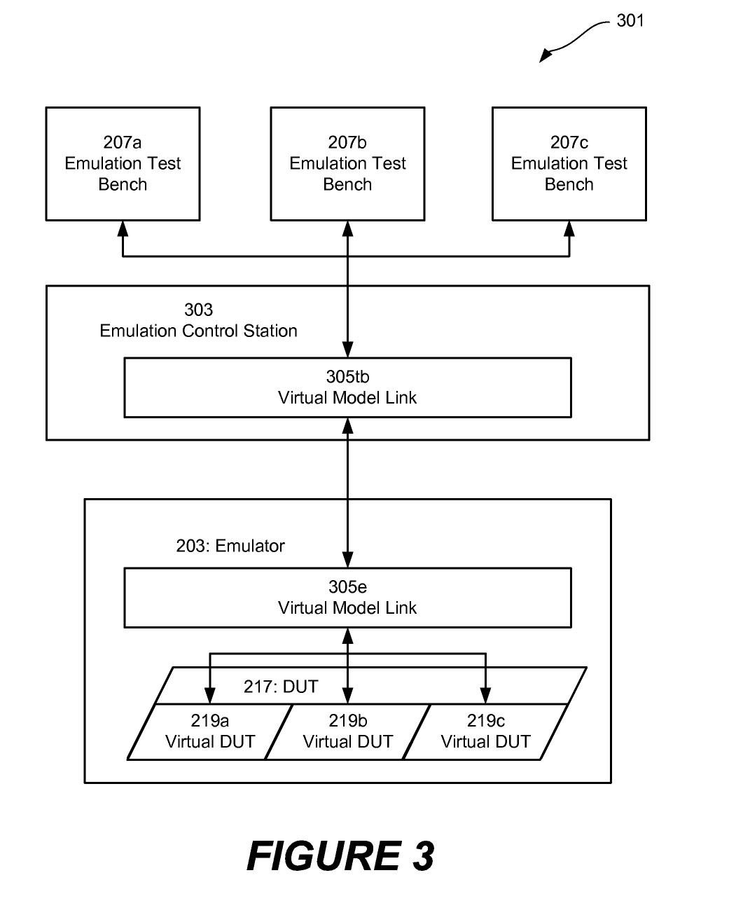

As stated above, various implementations of the invention are directed towards facilitating the concurrent emulation of multiple electronic designs on a single emulator. As indicated above, some emulation technologies provide for concurrent emulation by first partitioning the emulator into sections. Individual electronic designs can then be implemented and subsequently emulated in each section. FIGS. 2A and 3 illustrate exemplary emulation environments 201 and 301, which may be provided by various implementations of the present invention. The emulation environments 201 and 301 may be used to concurrently emulate multiple electronic designs in a single emulator without needing to partition the emulator into sections.

### Model Compaction

As can be seen from FIG. 2A, the emulation environment 201 includes an emulator 203, an emulation control station 205, and emulation test benches 207. In various implementations, the emulator 203 is a hardware emulator comprised of configurable logic components, which may be set up so that the behavior of an electronic design can be mimicked. As indicated above, in some implementations, these configurable logic components may be field-programmable gate arrays. In other implementations, these configurable logic components may be configurable application-specific integrated circuits. In order to “configure” an emulator to “emulate” an electronic design, a model for the electronic design is first generated. Subsequently, “configuration code” is generated from the model. This configuration code may then be used to cause the configurable logic components in the emulator 203 to implement the model. The model implemented in the emulator is often referred to as the “design under test” or “DUT”.

The emulation control station 205 and the emulation test benches 207 may be implemented using a programmable computer system executing software instructions stored on a computer readable medium. In some implementations, the programmable computing device 101 may be used to implement the emulation control station 205 and the emulation test benches 207. In further implementations, the emulation control station 205 and the emulation test benches 207 may be implemented on a single programmable computer system or multiple programmable computer system networked together.

As will be appreciated by those of ordinary skill in the art, once configured, the emulator 203 can then be used as a resource in a verification process. More specifically, the emulator 203 can be used to determine the behavior of the electronic design implemented in the emulator 203 under specific conditions. For example, during the verification processes, a test bench is used to provide input stimulus to the emulator. The test bench is typically also configured to verify the results of the emulation against expected results. As indicated, various implementations of the invention are applicable to facilitating the concurrent emulation of multiple electronic designs. Accordingly, the emulation environment 201 shows multiple test benches 207. These multiple test benches 207 will be described in greater detail below.

The emulation control station 205 is provided to facilitate the configuration of the emulator 203. As can be seen, the emulation control station 205 includes a model compaction module 209. The model compaction module 209 is configured to form a combined model 211 corresponding to the different electronic designs desired to be emulated on the emulator 203. For example, each of the emulation test benches 207 is shown referencing a model for an integrated circuit (IC Model) 213. The model compaction module 209 is configured to combine the models 213 corresponding to the electronic designs desired to be emulated by the emulator 203 to form the combined model 211. A model implementation module 215 then is provided in the emulation control station 205. The model implementations module 215 generates configuration code from the combined model 211 and then configures the emulator 203 to implement the combined model 211 as a DUT 217.

As those of ordinary skill in the art will appreciate, the DUT 217 now represents multiple electronic designs, or multiple instances of the same electronic design, or some combination of the two. Accordingly, the DUT 217 can be represented as including multiple models, referred to as “virtual DUTs.” For example, FIG. 2B shows the DUT 217 and virtual DUTs 219a-219c that correspond to the IC Models 213a-213c included within the DUT 217.

In various implementations, the IC models 213 will be represented as netlists. As those of ordinary skill in the art will appreciate, a netlist is a description of a circuit including the components comprising the circuit and their interconnections. Accordingly, the combined model 211 may be generated by merging the netlists into a single netlist. In certain implementations, the nets corresponding to the respective netlists will be kept separate in the merged netlist. In some implementations, specific nets, such as, for example, power nets may be consolidated. In some implementations, the netlists corresponding to the IC models 213 may be merged by instantiating them inside another netlist. This single netlist may be referred to as a top level netlist. Additionally, components and connections for performing various emulation activities, such as, for example, communicating messages with the emulation control station, multiplexing virtual channels onto physical channels, clock domain management for the virtual DUTs 219 may be generated and included in the top level netlist wrapper. Various emulation activities, such as those mentioned above, will be described in further detail below. Those of ordinary skill in the art will appreciate how to combine the IC models 213 into the combined model 211 without further explanation. However, additional details about generating the combined model 211 will be provided below.

With some implementations, generation of the combined model 211 and configuration of the emulator 203 to implement the combined model 211 as the DUT 217 will be done using the emulation control station 205, as shown in FIG. 2. For example, the model implementation module 213 may generate configuration code from the combined model 211 (e.g. or a top level netlist corresponding to the combined model 211), then the emulator 203 may be configured to implement the combined model 211 as the DUT 217. As detailed above, and further herein, multiple different configurations of emulation resources may be used to implement the combined model 211 as the DUT 217. For example, the DUT 217 may be implemented in a single reprogrammable processor (e.g. a field programmable integrated circuit or a custom reconfigurable integrated circuit), multiple reprogrammable processors, a single emulation board, multiple emulation boards, or some combination of these resources.

In some implementations, another computer system, such as, for example, one of the emulation test benches 207 may generate the combined model 211 and configure the emulator 203 to implement the combined model 211 as the DUT 217. Still further, with various implementations, another computer system, not represented in FIG. 2, may be used to generate the combined model 211 and configure the emulator 203 to implement the combined model 211 as the DUT 217. For example, the emulator 203 may be configured to implement the combined model 211 as the DUT 217 prior to initiating a verification process using the emulator 203.

### Emulation Message Communication

Turning now to FIG. 3, the emulation environment 301 shows the emulator 203, the test benches 207 and the DUT 217. More particularly, the emulator 203 is shown as implementing the DUT 217, and as a result, the virtual DUTs 219. An emulation control station 303 and virtual model links 305 are also shown in the emulation environment 301.

An emulation side virtual model link 305e and a test bench side virtual model link 305tb are shown. As indicated above, during an emulation process, various different types of “messages” are passed between the emulation test benches 207 and the emulator 203. For example, input signals to excite the DUT 217 may be passed between the test benches 207 and the emulator 203. Additionally, the emulated outputs from executing the emulator 203 with the input signals applied as inputs to the DUT 217 may be passed from the emulator 203 to the test benches 207. As the emulator 203 is configured to concurrently emulate multiple designs, multiple different input signals, corresponding to the different virtual DUTs 219 and multiple different emulated responses, will need to be communicated between the emulator 203 and the test benches 207.

Transmission of messages between the emulator 203 and the test benches 207 is commonly facilitated by transactors. A transactor is an interface between a test bench and the DUT 217. More specifically, the transactor provides a link between the signal level interface of the electronic design as represented by the DUT 217 and the transaction-level interface of the test benches 207, that is, the transactions of generating input signals, requesting trace data, etc. Transactors are typically provided for different types of communication buses that may be implemented in a design to be emulated, such as, for example, a universal serial bus (USB) or primary component interconnect (PCI). Furthermore, transactors are now commonly provided that are compliant with the Standard Co-Emulation APA: Modeling Interface (SCE-MI). Those of ordinary skill in the art will appreciate how to implement a transactor without further explanation. The virtual model links 305 may be implemented by transactors.

The virtual model links 305 are configured to pass messages between the test benches 207 and the corresponding virtual DUTs 219. In some implementations, the virtual model link 305e is configured to combine the various messages emanating from the virtual DUTs 219 into a single “stream” of message traffic for communication to the emulation control station 303, where the virtual model link 305tb is configured to separate the individual messages from the overall stream and pass the appropriate messages to the corresponding emulation test benches 207. With other implementations, the virtual model links 305 alternately or additionally are configured to maintain separate communication streams for each virtual DUT 219 and test bench 207. In still other implementations, the messages alternately or additionally may be multiplexed into a single signal, transmitted between the virtual model links 305, for example, by a joint test action group (JTAG) transmission mechanism, and then de-multiplexed into separate messages. In some implementations, a high speed serial link, such as, for example, a high speed signaling link (HSL) or a peripheral component interconnect (PCI) express link may be utilized to transmit messages over the virtual model links 305.

### Emulation Time Control

As indicated above, a number of different actions take place during a verification process, such as, for example, input signal generation or identification of trace information (e.g. emulated output or state information). Furthermore, the test benches 207 often include components that facilitate these verification actions. For example, input sequences are generated, and then used during emulation of the DUT 217. Additionally, “trace” information is often gathered during execution of the emulator 203. More specifically, the logical values stored in elements in the DUT 217 may be captured during execution of the emulator 203. Subsequently, these captured values may be used to “debug” any errors identified during verification. Those of ordinary skill in the art will appreciate that the test benches 207 often include different components that facilitate these actions. For example, the test bench may include a “debugger” component that will cause emulation information, such as state data, to be captured at specific intervals during emulation. Furthermore, the test benches 207 may include components that facilitate the execution of software using the emulated DUT 217 as a resource or as the target of the software execution. This is typically facilitated by providing software execution drivers for the DUT 217.

Various implementations of the invention separate these different test bench 207 components (e.g. input sequence generation, trace information capture, and software execution drivers) into what is referred to as “timed” and “untimed” operations. As those of ordinary skill in the art will appreciate, synchronous circuits operate according to a clock. The time interval that corresponds to processing a set number of instructions and which typically corresponds to the interval between consecutive rising edges of the clock (or, in some instances, consecutive falling edges of the clock) is referred to as one “clock cycle.” Accordingly, the verification operations that are processed based on the clock of the DUT 217 (such as, for example, trace information capture or software execution drivers) are categorized as the “timed” operations. Similarly, the verification operations that do not need to be processed based on the clock of the DUT 217 (such as, for example, input sequence verification) are categorized as untimed operations. With various implementations of the invention, the timed operations are implemented in the emulator 203, while the untimed operations are typically implemented in the emulation test benches 207.

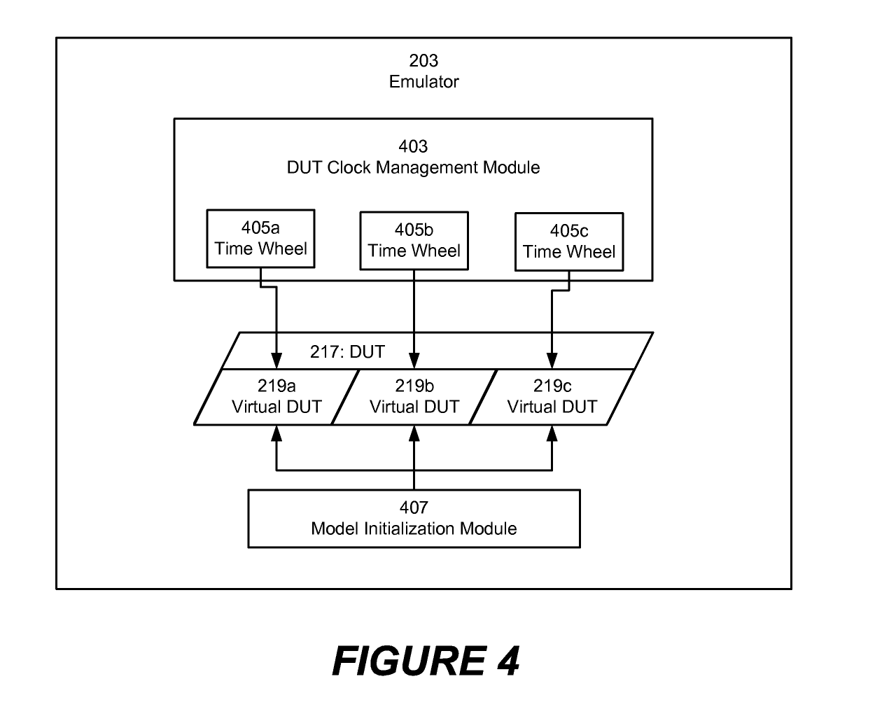

FIG. 4 shows the emulator 203, including the DUT 217 and Virtual DUTs 219. A DUT clock management module 403 and a model initialization module 407 (discussed below) are also shown in the emulator 203. The DUT clock management module 403 is configured to manage the clocks of the virtual DUTs 219. In various implementations, the DUT clock management module 403 generates a time wheel 405 for each virtual DUT 219 implemented in the DUT 217. Subsequently, during execution of the emulator 203, the processing of operations by a respective virtual DUT 219 can be “stalled” or paused by its corresponding time wheel 405, while for example, the corresponding emulation test bench 207 is performing a verification action that necessitates pausing the processing of operations by the respective virtual DUT 219.

In various implementations, a time wheel (e.g. the time wheel 405a) for a particular virtual DUT 219 (e.g. the virtual DUT 219a) may be implemented by generating a finite state machine corresponding to clock domain specific control signals for the virtual DUT 219. Subsequently, the finite state machine may be implemented in the emulator 203 and configured such that the emulation of one virtual DUT 219 may be “stalled” or “paused” at different times, independently of the emulation of the other virtual DUTs 219. More specifically, the emulation, or the processing of logical states and signal values within the emulator that correspond to a particular virtual DUT 219 may be paused by the time wheel 405 corresponding to that virtual DUT 219 while the processing of logical states and signal values within the emulator that correspond to other virtual DUTs 219 is unaffected.

For example, if during execution of the emulator 203, the virtual DUT 219b completed processing an input sequence and sent the emulated output sequence to the emulation test bench 207b, the processing of operations by the virtual DUT 219b could be paused by the time wheel 405b while receipt of the next input sequence from the emulation test bench 207b is awaited. As those of ordinary skill in the art will appreciate, this allows continuous execution of the emulator 203. More specifically, as in the example given here, this allows for the processing of operations by the other virtual DUTs (i.e. 219a and 219c) to continue while the processing of operations by the virtual DUT 219b is paused. Accordingly, as the time wheels 405 are independent from each other, some virtual DUTs 219 may continue to execute and have their clocks advanced while other virtual DUTs 219 do not.

Virtual Model Initialization

As stated above, FIG. 4 shows the emulator 203 including the model initialization module 407. The model initialization module 407 is configured to initialize or reset one of the virtual DUTs 219 to a particular state. More specifically, during execution of the emulator 203, a respective one of the virtual DUTs 219 may be reset to some state by the model initialization module 407 without impacting the state of the other virtual DUTs 219. For example, the model initialization module 407 may reset the virtual DUT 219a to a particular state while the states of the virtual DUTs 219b and 219c remain unchanged.

As indicated above, and as those of ordinary skill in the art will appreciate, the “state” of a respective DUT 219 references the logical values stored in the data storage elements within the DUTs 219. For example, a DUT 219 that included multiple flip-flops would “store” logical values in the flip-flops during emulation. These logical values at a point during emulation are referred to as the state at that point. Accordingly, in various implementations, the model initialization module 407 may place the virtual DUTs 219 in an initial state. As used herein, the initial state corresponds to where the logical values are unknown or unset, such as, for example, as would be the case when the virtual DUTs 219 were first turned on. With some implementations, the model initialization module 407 may place the virtual DUTs 219 in a known state. As used herein, the known state corresponds to a particular point in time during operation of the virtual DUTs 219. For example, if one of the virtual DUTs 219 were an SOC processor, the known state could correspond to the state of the virtual DUT 219 after a “boot sequence” had been applied to the processor.

### Illustrative Concurrent Emulation of Multiple Electronic Designs in a Single Emulator

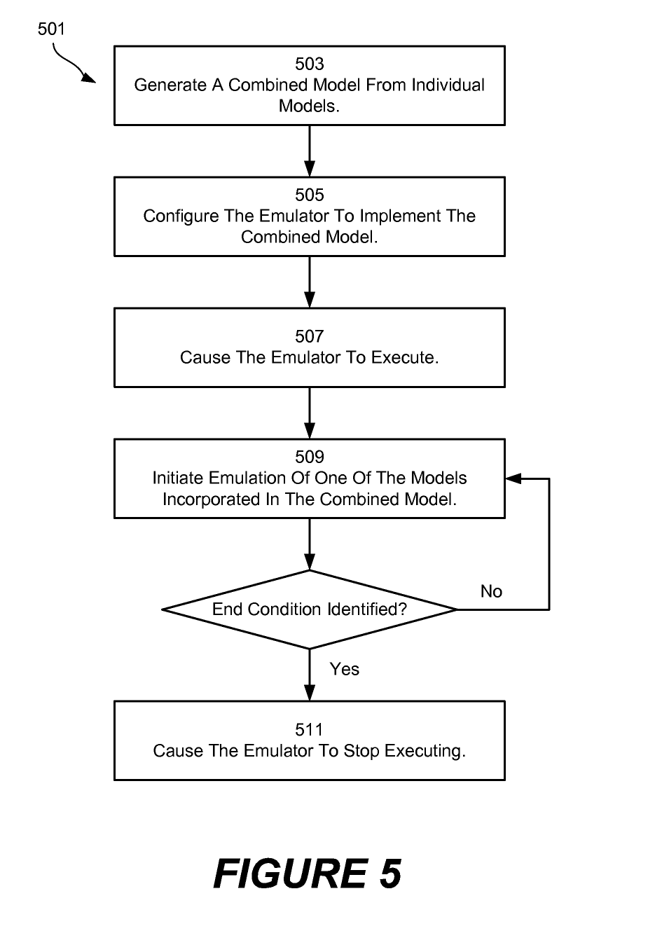

FIG. 5 shows a method 501 that may be provided for concurrently emulating multiple electronic designs in a single emulator 203 according to various implementations of the present invention. As can be seen from this figure, the method 501 includes an operation 503 for generating a combined model 211 from multiple IC models 213. As detailed above, the combined model 211 includes the virtual DUTs 219, which correspond to the IC Models 213. An operation 505 for configuring the emulator 203 to implement the combined model 211 is also provided. Subsequently, an operation 507 for causing the emulator 203 to execute and an operation 509 for initiating emulation of one of the virtual DUTs 219 are provided. Subsequently, as can be seen from this figure, the operation 509 for initiating emulation of one of the virtual DUTs 219 may be repeated until some end condition is identified. In various implementations, the end condition is that all desired emulation operations have been completed. With other implementations, the end condition is that a specified amount of time has elapsed since emulation started. After which, an operation 511 for causing the emulator 203 to stop executing is provided.

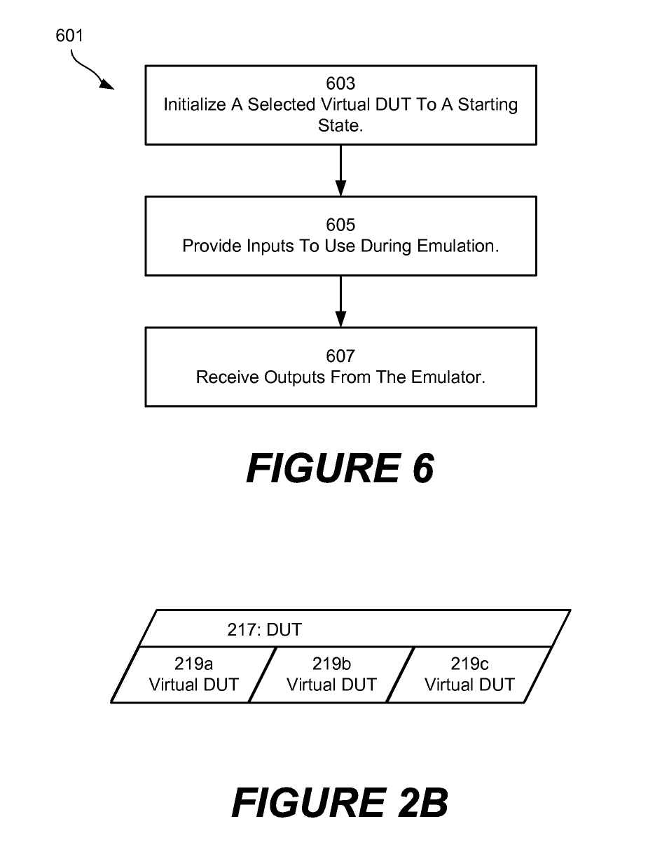

FIG. 6 shows a method 601 that may be provided to implement the operation 509.

As can be seen from this figure, the method 601 includes an operation 603 for initializing a selected one of the virtual DUTs 219 to a particular state, such as, for example, an initial state or a known state. An operation 605 for providing inputs to be applied to the selected virtual DUT 219 during emulation and an operation 607 for receiving output from the emulator 203 are also provided.

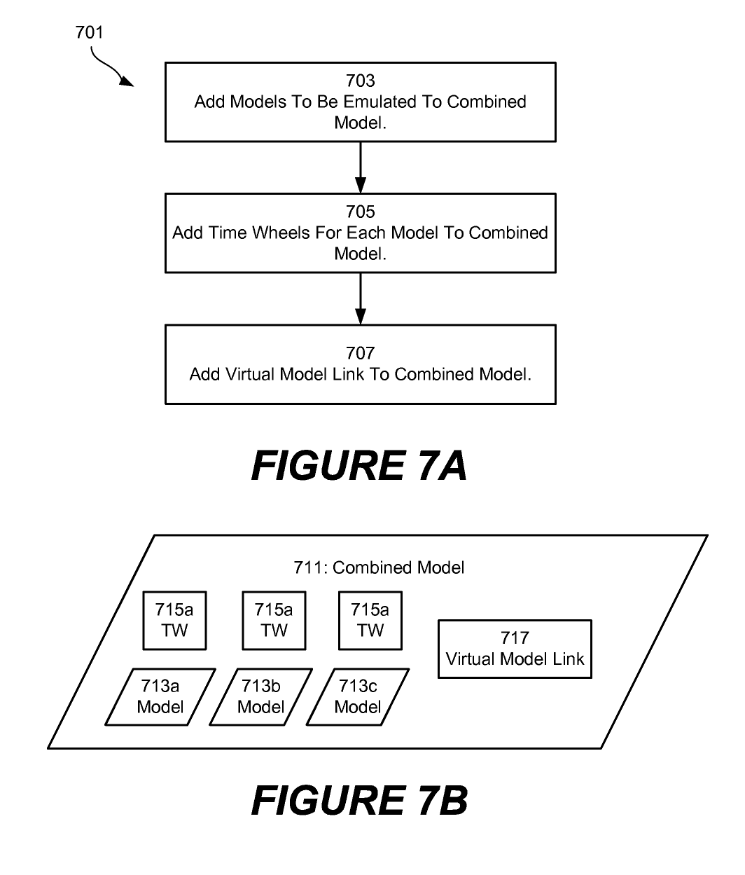

FIG. 7A shows a method 701 that may be provided to implement the operation 503 and generate a combined model. FIG. 7B shows a combined model 711, which will be referenced in describing the method 701. As can be seen from these figures, the method 701 includes an operation 703 for adding the models to be emulated (e.g. the IC models 213) to the combined model 711. In various implementations, this process involves compiling the models, as detailed above, to form the models 713. An operation 705 for adding time wheels 715 to the combined model is also provided. In various implementations, a time wheel 715 for each model 713 will be provided. In alternative implementations, some models 713 may share a time wheel. For example, it may be advantageous to have multiple models 713 process the same instructions. Accordingly, only a single time wheel 715 will be needed to manage the emulation for those models 713.

An operation 717 for adding a virtual model link 717 to the combined model 711 is also provided in the method 701. As indicated above, the virtual model link may be configured to multiplex messages for communication between the models 713 and test benches (e.g. the test benches 207). Accordingly, in some implementations, the virtual model link 717 will be multiplexor logic arranged to multiplex these messages as described above.

### Conclusion

Although certain devices and methods have been described above in terms of the illustrative embodiments, the person of ordinary skill in the art will recognize that other embodiments, examples, substitutions, modification and alterations are possible. It is intended that the following claims and their equivalents cover such other embodiments, examples, substitutions, modifications and alterations within the spirit and scope of the claims and their equivalents.

1. An emulation environment for concurrently emulating multiple integrated circuit designs, the emulation environment comprising:
a hardware emulator configurable to implement a combined model that corresponds to multiple electronic design models;
an emulation clock manager configured to maintain independent clocks for each of the multiple electronic design models in the combined model during an emulation process; and
a virtual model link configured to facilitate message traffic between the emulator and multiple test benches that may be employed to perform hardware assisted verification processes using the emulator as a resource.

2. The emulation environment recited in claim 1, wherein the emulation clock manager is implemented within the hardware emulator.

3. The emulation environment recited in claim 1, further comprising an emulation control configured to initialize a portion of the combined model as implemented in the emulator to reflect the operating state of the one of the multiple electronic designs that the portion of the combined model corresponds to without affecting the states of the other portions of the combined model.

4. The emulation environment recited in claim 3, wherein the virtual model link includes a component residing on the hardware emulator and a component residing on an emulation control station.

5. The emulation environment recited in claim 4, wherein the components of the virtual model link are configured to multiplex and demultiplex messages corresponding to message traffic for the hardware assisted verification processes.

6. The emulation environment recited in claim 1, wherein the combined model further includes independent time wheels for each of the multiple electronic designs included in the combined model.

7. The emulation environment recited in claim 1, further comprising multiple test benches configured to perform concurrent hardware assisted verification processes using the emulation environment as a resource, wherein the multiple test benches are configured such that timed components related to the hardware assisted verification processes are executed on the emulator and untimed component related to the hardware assisted verification processes are executed on the respective test benches.

8. The emulation environment recited in claim 7, wherein the multiple test benches are implemented on one or more computer systems.

9. A computer-implemented method for concurrently emulating multiple electronic designs in a single emulator, the method comprising:
generating a combined model from multiple electronic design models, each of the multiple electronic design models representing one of the multiple electronic designs;
causing an emulator to implement the combined model; and
routing message traffic between the emulator and multiple test benches performing hardware assisted verification processes.

10. The computer-implemented method recited in claim 9, wherein routing message traffic between the emulator and the multiple test benches performing hardware assisted verification processes using the emulator as a resource comprises
using at least two virtual model links.

11. The computer-implemented method recited in claim 9, wherein routing message traffic between the emulator and the multiple test benches performing hardware assisted verification processes using the emulator as a resource comprises:
multiplexing the messages related to emulation of the combined model into a data signal;
transmitting the data signal off the emulator;
demultiplexing the data signal and routing the messages to the respective ones of the test benches.

12. The computer-implemented method recited in claim 9, further comprising initializing a portion of the combined model as implemented in the emulator to reflect the operating state of the one of the multiple electronic designs that the portion of the combined model corresponds to without affecting the states of the other portions of the combined model.

13. The computer-implemented method recited in claim 9, wherein routing message traffic between the emulator and the test benches performing hardware assisted verification processes using the emulator as a resource comprises:
receiving messages corresponding to the message traffic from a plurality of the test benches;
multiplexing the messages into a data signal;
transmitting the data signal to the emulator; and
demultiplexing the data signal on the emulator.

14. The computer-implemented method recited in claim 9, further comprising pausing emulation of one of the electronic design models implemented in the combined model while emulation of the other electronic design models implemented in the combined model continues.

15. The computer-implemented method recited in claim 14, further comprising resuming emulation of the electronic design model implemented in the combined model that was paused.

16. A computer readable storage medium storing the combined model generated by the method of claim 6.

17. A computer readable storage medium storing computer executable instructions which when executed by a computer system cause the computer system to perform the method of claim 6.

18. A computer readable medium storing computer executable instructions which when executed by a computer system perform a method, the method comprising:
causing an emulator to implement a combined model corresponding to multiple electronic designs to be emulated; and
routing message traffic between the emulator and a plurality of test benches configured to perform hardware assisted verification.

19. A computer readable medium storing computer executable instructions which when executed by a computer system perform a method, the method comprising:
generating a combined model from multiple electronic design models, each of the multiple electronic design models representing one of the multiple electronic designs; and
generating independent time wheels for each of the multiple electronic design models.

20. The computer readable medium recited in claim 19, further comprising adding the independent times wheels to the combined model.

21. The emulation environment recited in claim 1, wherein the virtual model link is a first virtual model link and further including using at least a second virtual model link to facilitate message traffic between the emulator and multiple test benches.
